(19) United States
(12) Patent Application Publication
(10) Pub. No.: US 2016/0227718 A1
(43) Pub. Date: Aug. 11, 2016

(54) Fluid Emitter concepts for feeding the root system of a plant

(71) Applicants: John Matthews, Tucson, AZ (US); William Dunbar, Tucson, AZ (US)

(72) Inventors: John Matthews, Tucson, AZ (US); William Dunbar, Tucson, AZ (US)

(73) Assignee: William Dunbar, Tucson, AZ (US)

(21) Appl. No.: 14/619,734

(22) Filed: Feb. 11, 2015

(51) Int. Cl. A01G 29/00; B28B 5/00; B28B 19/00; A01G 1/00

(52) U.S. Cl. CPC A01G 29/00; A01G 1/001; B28B 5/00; B28B 19/0038

(57) ABSTRACT

The present invention provides a new and useful (i) plant root feeding device (ii) plant root feeding system, (iii) method of feeding a plant, and (iv) method of manufacturing a plant root feeding device. The plant root feeding device comprises a fluid container (emitter) formed of semi permeable material that allows fluid to pass from the inside of the container to a plant root located in ground in proximity to the fluid container. The fluid container has a fluid inlet opening, and a fluid inlet tube is in fluid communication with the fluid inlet opening of the fluid container. The fluid inlet tube has a fixed, fluid sealed coupling to the fluid inlet opening of the fluid container, and the fluid container has a configuration that enables it to be located in ground in proximity to an in ground root system of a plant, and a permeability that enables fluid to pass from the inside of the container to the in ground root system of a plant in proximity to the fluid container.

### BACKGROUND

The present invention relates to new and useful concepts in fluid emitters designed to feed the root system of a plant. These concepts are designed to provide efficient and economical feeding of the root system of a plant, without a complicated irrigation system, and without the need to saturate the soil in which the plant root system is provided. The fluid emitter concept of the present invention is designed to provide the root system of a plant with the fluid it needs, and is seeking, when the root system needs the fluid, and in a manner that does not waste the fluid. The moisture field that is created by the ball limits further emission, from the ball. The fluid may be just water, but can also be a mixture of water and plant food that is dissolved or suspended in the water.

The present invention (sometimes referred to as Olla balls, applicants' name for applicants' new fluid emitter concept) has a number of features that depart from, and are believed to improve on traditional ways of delivering moisture to the root system of plant(s).

For example, traditional irrigation methods require high pressure plumbing, whereas Olla balls use gravity fed water. Traditional irrigation systems customarily water areas that are not desirable locations, whereas Olla balls concentrate on an area to only introduce water where needed. Still further, unlike most irrigation systems, with applicants' Olla balls, irrigation fluid flows up from emitter to roots, not down from soil surface, and this should result in less water usage. In addition, traditional irrigation requires electrical sources for timers, mechanical components that require water pressure and human labor to monitor such timers to irrigate, whereas Olla balls work on gravity principle to where water travels by gravity to the Olla balls, which stay full until soil and minerals draw fluid from the ball therefore delivering moisture to the plant root system. In a subterranean environment emission of water from the Olla balls to the soil remains constant until hydrostatic pressure keeps the ball from further emission. The water travels slow enough to acclimate to soil temperature in a subterranean environment.

Also, traditional irrigation can deliver extremely hot or cold water to plant which could shock their systems, whereas Olla balls water temperature remains the same as the soil temperature.

In comparison to traditional olla pots (that contain water that is buried with the open filler neck exposed, next to the plants), which require manual labor of delivering water to fill pots and has an unregulated schedule of feed of water, due to evaporation, human or animal interruption, breakage from the top inlet watering hole, with the applicants' Olla ball concept, planting space is increased due to the efficiency of the olla ball verses the olla pot, the applicants' Olla ball concept provides constant feeding source to root system, and results in top soil being usually free(er) of bugs/mosquitoes due to the dryness of the top soil—not propagating outside unwanted seed population and excess moisture due to the Olla ball being underground.

In comparison to aquaponic systems, which are completely different from the applicants' Olla ball concept, because they deliver water directly to the roots without soil, and deliver nutrients from fish excrement, the Olla Ball concept allows a plant root system to absorb natural soil nutrients as well as draw moisture from the Olla Ball itself because of the clay make up of the ball, and nutrients that may be added to the clay that is used to form the Olla ball.

In comparison to hydroponic systems, which also rely on timers, electricity, and large amounts of water, Olla balls do not.

The applicants' Olla ball concept also has a number of general attributes that makes it attractive as a plant root system feeding device, system and method, e.g.,
a. applicants' Olla ball ceramic emitter is composed of natural earth ingredients, therefore applicants' emitter is environmentally sound because its decomposure should be environmentally friendly and should take place over time while providing a water/feeding source to the desired plants. Moreover, with applicants' concept, fluid flows through a porous emitter, and as it flows it dissolves mineral nutrients in walls of clay emitter and transmits these nutrients to plants.
b. Also, applicants' ceramic emitters are believed to be fun and easy to install, because all that should be needed is a bulb planting device and all that is needed to be done is to scoop out dirt, place the Olla ball in the hole and plant.
c. The amount of Olla balls that can be fed from a single reservoir is vast. Traditional emitters are limited to water pressure.
d. Olla balls will not over water or under water, because the moisture is always available on demand by the soil and plant root system.
e. ceramic part of the Olla ball is made of earthenware therefore is biodegradable.
f. A leak is easy to spot, because the top soil will be wetter than normal.
g. Drain holes are not necessary in potted plants with Olla ball. This is because the moisture is suspended in the soil.
h. Olla balls can be used indoors, with a floatless reservoir.
i. Olla balls are silent, whereas traditional irrigation methods are not.
j. Olla balls have a long useful lifetime.
k. No special tools are needed to install a typical Olla ball system.
l. When installed properly, the Olla ball can withstand freezing temperatures.

### SUMMARY OF THE INVENTION

The present invention provides a new and useful (i) plant root feeding device (ii) plant root feeding system, (iii) method of feeding a plant, and (iv) method of manufacturing a plant root feeding device.

The plant root feeding device comprises a fluid container (emitter) formed of semi permeable material that allows fluid to pass from the inside of the container to a plant root located in ground (i.e. in the soil in which the plant root system is located) in proximity to the fluid container. The fluid container has a fluid inlet opening, and a fluid inlet tube is in fluid communication with the fluid inlet opening of the fluid container. The fluid inlet tube has a fixed, fluid sealed coupling to the fluid inlet opening of the fluid container, and the fluid container has a configuration that enables it to be located in ground in proximity to an in ground root system of a plant, and a permeability that enables fluid to pass from the inside of the container to the in ground root system of a plant in proximity to the fluid container. With the device, system and method of the present invention, without anything more than the effect of gravity and the moisture content of the soil; as the plant root system absorbs fluid from the surrounding soil, the soil draws fluid into it from the emitter by means of osmotic pressure. Thus, nothing pushes the fluid from the container into the soil except gravity and osmosis. Fluid moves from the container to the plant via the soil and the plant root system.

In this application reference to the fluid container (emitter) being in “proximity” to an in ground root system of a plant means that the fluid container is within 5 inches of the in ground root system of the plant.

In a plant root feeding device according to the present invention, the fluid container (emitter) preferably has a ball shaped configuration. Also, the fluid container is formed of semi permeable ceramic material. Moreover, the fluid inlet opening has a ceramic collar that has a sealed, substantially permanent connection with the fluid container, and the fluid inlet tube is integrally connected with the ceramic collar. In addition, the ceramic container has a predetermined wall thickness, and the ceramic collar has a thickness that is larger than the predetermined wall thickness of the ceramic container. The ball shaped container has an outer diameter in the range of 1.5 inches to 5 inches and a wall thickness in the range of 0.25 inches to ½ inches, and the ratio of the outer diameter of the container to the wall thickness is about 20 to 1. The ceramic material is barium free, and the ceramic material includes sodium silicate.

In a plant root feeding system, according to the present invention, the fluid container is located in proximity to the in ground root system of a plant, the fluid container allows fluid to pass from the inside of the container to the surrounding soil and then to the in ground root system of the plant, the fluid container having a fluid inlet opening, and the fluid inlet tube has a distal end in fluid communication with a source of plant feeding fluid.

In a method of feeding a plant root, according to the present invention, the plant root feeding system, as described above, is provided, with the fluid container located in the surrounding soil and in proximity to the in ground root system of the plant, and plant feeding fluid is supplied to the fluid container via the fluid inlet tube. A fluid reservoir is in fluid communication with the distal end of the fluid inlet tube, to provide a source of plant feeding fluid for the container. Also, it is preferred that the fluid reservoir is located above the level of the fluid container, to enable a gravity feed of plant feeding fluid from the reservoir to the fluid container via the fluid feeding tube.

In a method of manufacturing a ceramic fluid device (emitter), according to the present invention, the hollow ball shaped container is produced by providing a ceramic mixture that includes a clay, water and sodium silicate, and providing a casting mold formed of casting plaster. The casting mold is configured to cast a hollow ball shaped container with the configuration of a collar support at its upper end. The ceramic mixture is slip cast in the casting mold, and the slip cast ceramic mixture is fired in a predetermined fashion to produce a predetermined porosity in the ball shaped fluid container. The ceramic collar and fluid inlet tube are sealed to the upper end of the hollow ball shaped container with the fluid inlet tube in fluid communication with the interior of the hollow ball shaped container.

There are two preferred formulations of the ceramic mixture that is used to form the ceramic fluid container. In one formulation, the principal components of the mixture are Laguna 207 dry clay, soda ash, water and sodium silicate. In another formulation, the principal components of the mixture are Talc, KT ball clay, Custer Velspar Ball Clay, soda ash, water and sodium silicate.

In a preferred version of the method of manufacturing the ceramic emitter, the ceramic collar is produced by providing a preformed collar form, coating the collar form with the slip casting ceramic mixture, and placing the coated ceramic collar form in the collar support at the upper end of the container, such that the coated ceramic collar form when set in the container and fired with the container has a sealed relationship with the collar support at the upper end of the fluid container. The collar form has a central opening to enable the coated collar form to be coupled and sealed to a fluid inlet tube, with the fluid inlet tube in fluid communication with the interior of the ball shaped container.

Other features of the present invention will become further apparent from the following detailed description and the accompanying drawings.

### BRIEF DESCRIPTION OF THE DRAWINGS

FIG. 1 is a three dimensional illustration of a ceramic plant root system feeding device (emitter), according to the present invention;

FIGS. 2, and 3 are side and top views, respectively, of a fluid inlet tube for a plant root feeding system, according to the principals of the present invention;

FIG. 4 is a top view of the ball shaped portion of the ceramic emitter of FIG. 1;

FIG. 5 is a sectional view of the ball shaped portion of the ceramic emitter, taken from the direction 2-2 in FIG. 4, and showing some exemplary dimensions for the emitter;

FIG. 6 is a top view of the ceramic emitter of FIG. 1;

FIG. 7 is a sectional view of the ceramic emitter, taken from the direction 3-3 in FIG. 6, and showing some exemplary dimensions for the emitter;

FIG. 8 is a schematic illustration of a plant root feeding system, in accordance with the present invention;

FIG. 9 is a schematic illustration of a casting mold for casting the ball shaped portion of the ceramic emitter; and

FIG. 10 is a schematic illustration of the manufacture steps in producing the ceramic emitter of the present invention.

### DETAILED DESCRIPTION

As discussed above, the present invention relates to a new and useful (i) plant root feeding device (ii) plant root feeding system, (iii) method of feeding a plant, and (iv) method of manufacturing a plant root feeding device.

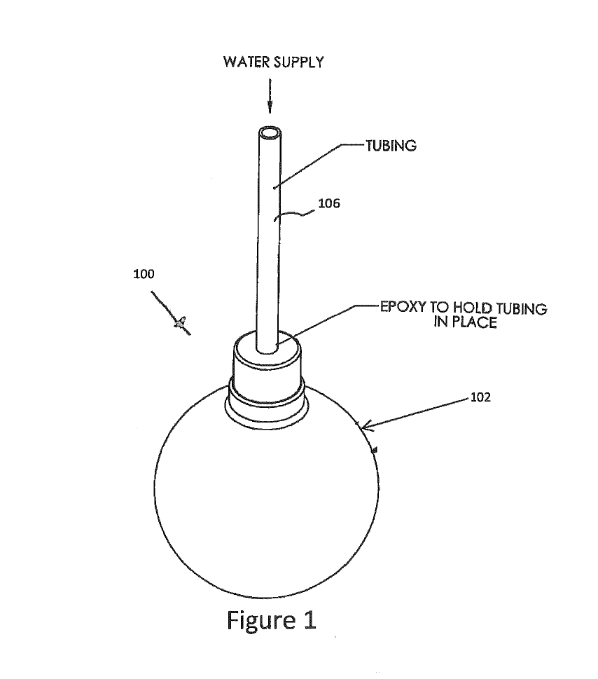

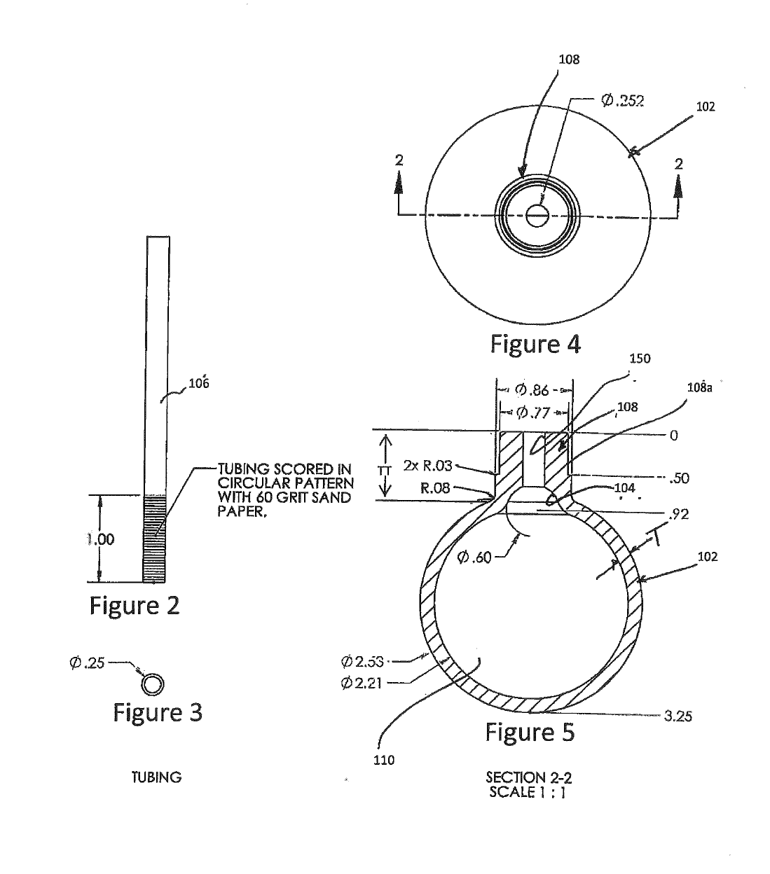

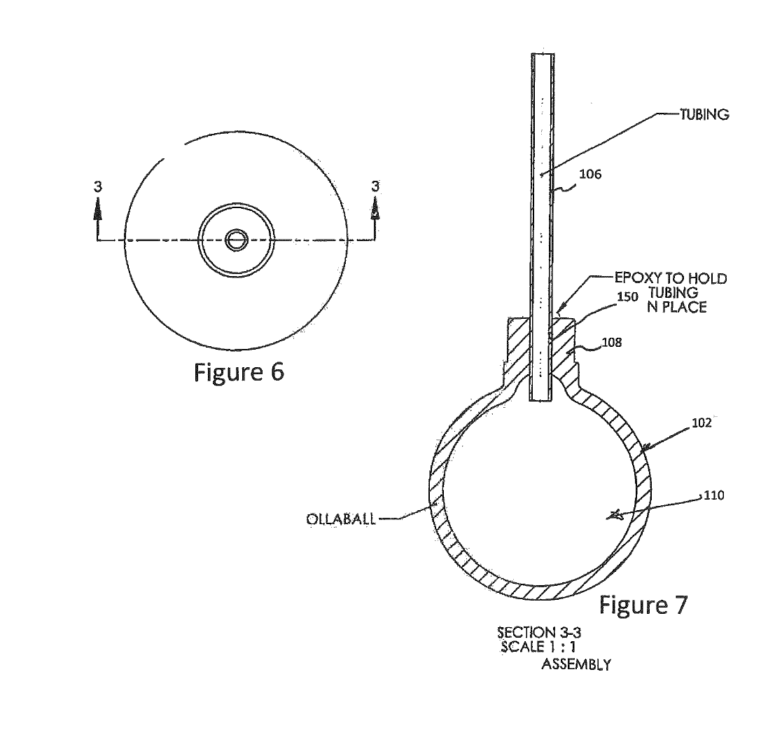

FIGS. 1-7 show the plant root feeding device and the plant root feeding system according to the present invention. The plant root feeding device 100 comprises a fluid container 102 (emitter) formed of semi permeable material that allows fluid to pass from the inside of the container to a plant root system located in ground in proximity to the fluid container. The fluid container 102 has a fluid inlet opening 104, and a fluid inlet tube 106 is in fluid communication with the fluid inlet opening of the fluid container. The fluid inlet tube 106 has a fixed, fluid sealed coupling to the fluid inlet opening 104 of the fluid container, and the fluid container 100 has a configuration that enables it to be located in ground in proximity to an in ground root system of a plant, and a permeability that enables fluid to pass from the inside of the container to the in ground root system of a plant in proximity to the fluid container.

In this application reference to the fluid container (emitter) 100 being in “proximity” to an in ground root system of a plant means that the fluid container is within 5 inches of the in ground root system of the plant. Also, the term “plant” encompasses flowers, trees or any other sort of member of the kingdom Plantae that would have an in ground root system that needs fluid to grow and survive.

In a plant root feeding device according to the present invention, the fluid container (emitter) 100 preferably has a ball shaped configuration (see e.g. FIGS. 1, 5, 7). Also, the fluid container is formed of semi permeable ceramic material. Moreover, the fluid inlet opening 104 has a ceramic collar 108 that has a sealed, substantially permanent connection with the fluid inlet opening 104 of the fluid container (see e.g. FIG. 5), and the fluid inlet tube 106 is integrally connected with the ceramic collar 108, and is in fluid communication with the hollow interior 110 of the fluid container 102 (see e.g. FIG. 7). In addition, the ceramic container 102 has a predetermined wall thickness T (FIG. 5), and the ceramic collar 108 has a thickness TT that is larger than the predetermined wall thickness T of the ceramic container. The ball shaped container 102 is preferably circular in cross section (see FIG. 5) with an outer diameter in the range of 1.5 inches to 5 inches and a wall thickness T in the range of 0.25 inches to ½ inches, and the ratio of the outer diameter of the container to the wall thickness is about 20 to 1. The ceramic material is barium free, and the ceramic material is formed from a clay mixture that includes sodium silicate as a deflocculating agent.

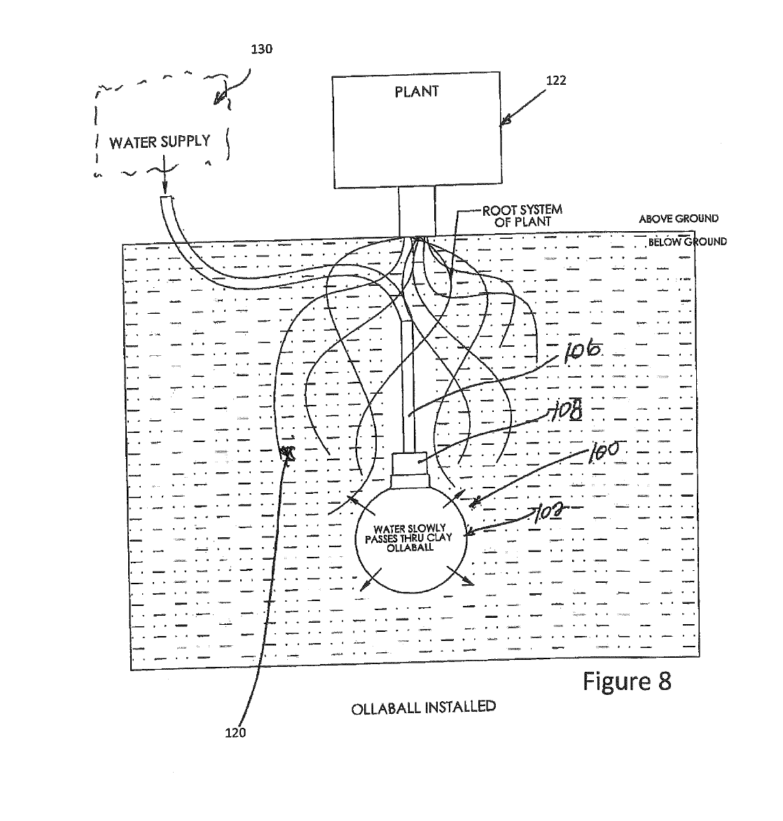

As seen from FIG. 8, in a plant root feeding system according to the present invention, the fluid container (emitter) 102 is located in proximity to the in ground root system 120 of a plant 122. The fluid container is semi permeable and allows fluid to pass, e.g. by osmotic pressure, from the hollow interior 110 of the container to the soil which supports the in ground root system 120 of the plant. The fluid inlet tube 106, which is supported in the collar 108, is in fluid communication with the hollow interior of the ceramic container and extends upward from the container, and has a distal end in fluid communication with a source 130 of plant feeding fluid. The source 130 of plant feeding fluid can be, e.g. a fluid reservoir. The plant feeding fluid can be water, or water combined with nutrients that are desirable, or necessary, for healthy plant growth and sustenance.

There are two preferred formulations of the mixture that is used to form the ceramic fluid container 102. In one formulation, the principal components of the mixture are Laguna 207 dry clay, soda ash, water and sodium silicate. In another formulation, the principal components of the mixture are Talc, KT ball clay, Custer Velspar Ball Clay, soda ash, water and sodium silicate. In each formulation, the sodium silicate is a deflocculating agent. Also, it should be noted that the formulations, and the ceramic container produced from the formulation, are free of barium.

The method of feeding a plant root system, according to the present invention, can be appreciated from FIG. 8. In a method of feeding a plant root, according to the present invention, the plant root feeding system, as described above, is provided as shown in FIG. 8, with the fluid container located in the soil in which the plant root system is embedded, and in proximity to the in ground root system 120 of the plant 122. Plant feeding fluid is supplied to the fluid container from the source (e.g. reservoir) 130 via the fluid inlet tube 106, as shown in FIG. 8. The fluid reservoir 130 is in fluid communication with the distal end of the fluid inlet tube 106, to provide a source of plant feeding fluid for the container. Also, it is preferred that the fluid reservoir 130 is located above the level of the fluid container, to enable a gravity feed of plant feeding fluid from the reservoir to the fluid container via the fluid feeding tube.

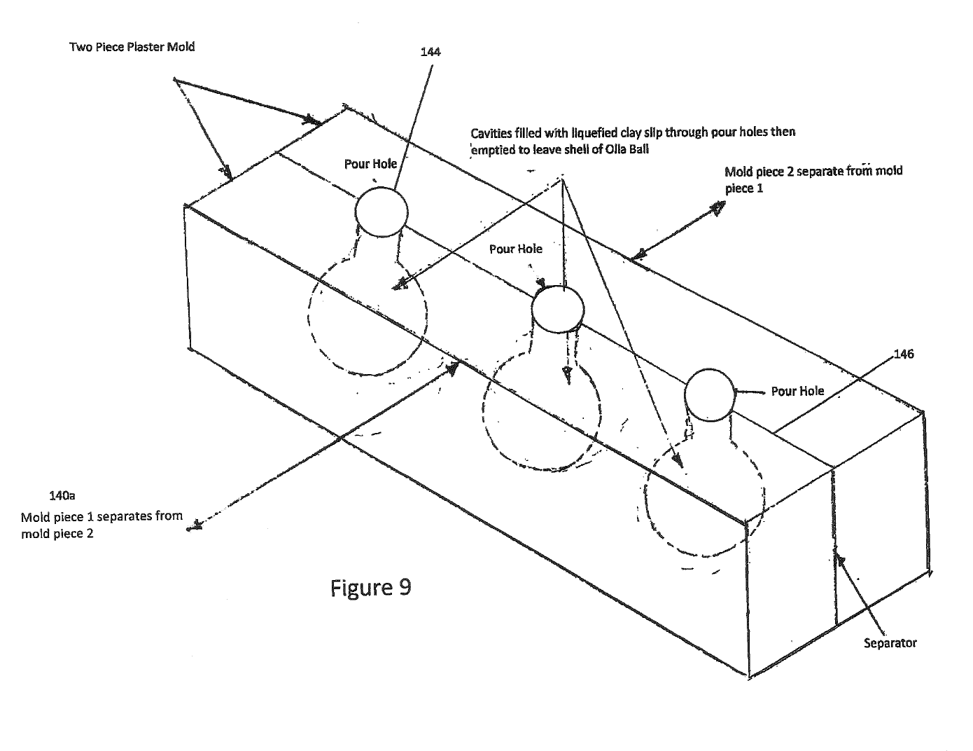

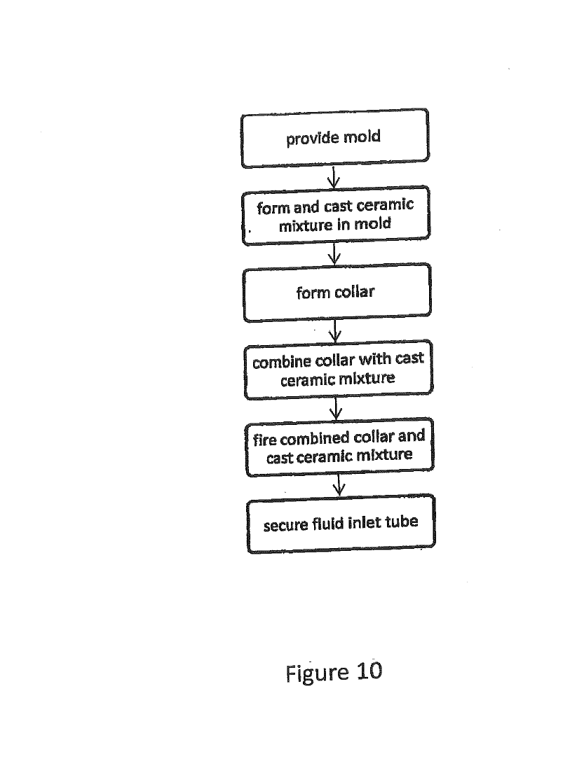

The method of manufacturing the ceramic fluid emitter, according to the principles of the present invention, can be appreciated from FIGS. 5, 9 and 10. The hollow ball shaped container is produced by providing a ceramic mixture that includes a clay, water and sodium silicate, and providing a casting mold formed of casting plaster. The casting mold is formed in two halves 140a, 140b, and is configured to cast a hollow ball shaped container with an inlet opening having the configuration of a collar support 142 at its upper end. The casting mold has several mold cavities, each of which is configured to cast an exact replica of the container 102 shown in FIG. 5, and the collar support is the replica of the collar support surface 108a shown in FIG. 5. The casting mold walls preferably are preferably coated with multiple coats of nitrocellulose lacquer, and also with vegetable oil as a release coating. The ceramic mixture is slip cast in the casting mold, and the slip cast ceramic mixture (with the collar 108) is fired in a predetermined fashion to produce a predetermined porosity in the ball shaped fluid container 102. The ceramic fluid inlet tube 106 is then sealed to the collar 108 at the upper end of the hollow ball shaped container with the fluid inlet tube 106 extending through the collar 108 and the fluid inlet opening, and in fluid communication with the hollow interior 110 of the ball shaped container.

In a preferred version of the method of manufacturing the ceramic emitter, the ceramic collar 108 is produced by providing a preformed collar form (e.g. from plastic or any other suitable material), coating the collar form with the slip casting ceramic mixture, and placing the coated ceramic collar form in the collar support at the inlet opening at the upper end of the container, such that the coated ceramic collar form when set in the container and fired with the container has a sealed relationship with the collar support at the upper end of the fluid container. The collar form has a central opening 150 to enable the coated collar form to be coupled and sealed to the fluid inlet tube, with the fluid inlet tube extending through the collar and in fluid communication with the hollow interior of the ball shaped container.

As described above, there are two preferred ceramic clay formulations for use in producing the ceramic emitter according to the present invention. One formulation uses Terra Cotta Clay. The other formulation uses White Clay.

More specifically, as an example, the formulation using Terra Cotta clay has as its primary ingredients, 300 pounds Laguna 207 dry clay, 23 pounds of H20, 86 grams of soda ash, and 16 to 32 ounces of sodium silicate that is used to deflocculate the clay as needed. As another example, the formulation using White clay, has as its primary ingredients, 150 pounds of Talc, 100 pounds of KT ball clay, 50 pounds of Custer Velspar Ball clay, 86 grams of Soda Ash, 23 pounds of H2O, and 16 to 32 ounces of sodium silicate that is used to deflocculate the clay as needed. As the clay formulation is being mixed, the sodium silicate is added until the clay moves fluidly (to a visual observations) in the mixing tank.

When the clay is slip cast to the desired shape, it is then fired to complete the ceramic emitter. The firing schedule is predetermined based on the desired porosity of the ceramic emitter. As an example, firing schedules for both clays, are as follows:
a. For a less porous lower water emission: The ceramic emitter is fired in an electric kiln to cone 04 at 1942 degrees Fahrenheit.
b. For a medium porous medium water emission: The ceramic emitter is fired in an electric kiln to cone 05 at 1888 degrees Fahrenheit.
c. For the most porous and highest water emission: The ceramic emitter is fired in an electric kiln to cone 06 at 1828 degrees Fahrenheit.

The manufacturing process in the making of the mold to make the emitter is as follows:
a. The casting molds are made of casting plaster, that is the geometric opposite of the part (i.e. the casting molds are the geometric opposites of the part shown in FIG. 5).
b. The casting mold parts 140a, 140b are made of a hydrostone cement master. Both mold parts have male and female portions that produce molded male and female molded portions that mate the two casting molds for maximum sealing during casting. The master mold is an exact replica of the part, in 2 halves, dividing the ball with collar, directly down the middle of the ball with the collar at the top. At the top of the collar there is a pour hole 144 to allow the clay slip to fill the ball. The master mold parts 140a, 140b are placed side by side on a level, solid, non stick surface, such as a laminate counter top. Mold forms are placed and clamped in a square around the master mold formed by the mold parts 140a, 140b. A plastic divider 146 is placed between the mold formed by the mold parts 140a, 140b to create the two casting mold parts leaving a quarter inch of space at either end to allow plaster to flow and fill both mold parts at once. For a casting mold that can produce three emitters at once, seven pounds of dry casting plaster are mechanically mixed with five pounds of H2O. The mixture is then immediately poured into the mold form containing both halves of the cement master molds. Once the plaster is solid and starts to get warm to the touch, the mold forms are pulled away from the two master and casting mold parts 140a, 140b. At this point, the master and casting molds are ready to be separated. Once separated, the male and female portions of the molded cast halves of the molded containers are slightly pressed together and set to dry into the molded containers. Once dry the molded containers are ready to use for slip casting the ceramic part of the emitter.

The manufacturing process in the making of the ceramic part of the emitter is as follows (the materials, equipment described herein are exemplary as applicants' preferred equipment and materials):

Equipment Needed:
a. Slip tank table with mixer, clay pump, hose and gas pump style filler nozzle.
b. Casting molds.
c. Slab roller fitted with coarse canvas.
d. ¾″ clay hole cutter.
e. ¼″ clay hole cutter.
f. Small artist paint brush.
g. Fine sanding pad.
h. Ceramic kiln
i. Sponge
j. Water bowl

### Materials Needed:

k. Clay mixes as described above in the clay formulations.
l. Ready made, solid wet clay blocks, with similar characteristics, as slip formulas described above in clay formulations.

### Mixing Clay Process:

m. Add 17 gallons of water and half of the sodium silicate to slip tank including soda ash if applicable.
n. Turn on mixer and let mix for 30 minutes.
o. Add 1 bag of clay to mixing tank at a time, until all solids are liquefied.
p. Add talc one bag (e.g. a 50 lb. bag) at a time, in the same fashion, if applicable. Continue this process until slip has a consistency of thinned pancake batter. Adjust liquid ingredients as needed.
q. Continue mixing for 3 hours. Let slip stand for 24 hours. After 24 hours, turn on mixer, and adjust liquid ingredients, as necessary. Continue to mix for 2 hours.
r. As the clay formulation is being mixed, the sodium silicate is added until the clay moves fluidly (to a visual observations) in the mixing tank.

### Casting Process for the Ceramic Part of the Emitters is as Follows:

s. Place four to six mated casting molds together flat, on slip tank table, with pour holes up, and secure them together with a mold strap. Turn on mixer, and clay pump.
t. Using gas pump style filler nozzle, fill all molds with clay slip. Let sit and monitor fill levels, topping off as necessary.
u. After one hour, turn molds perpendicular to the table and let drain to allow the pour holes to form. Then, turn molds face down to allow the molds to fully drain.
v. Turn upright and let molds sit. When clay feels to be firm, release mold strap, and separate molds from one another. Scrape excess clay from top of mold pour holes.
w. Let molds sit unopened, until there is a 1/16 gap between the clay around the pour hole and the casting mold.
x. At this point, it is time to check for proper mold release from part. Turn mold, long side down, with pour hole pointed away. Gently lift one half of mold straight up. If mold does not separate easily, allow more dry time. Pulling too soon will destroy the part.
y. Once mold halves are successfully separated, parts can be extracted. Gently pull part from mold, and pull excess pour hole clay from part. Place parts on foam egg crate and cover with plastic until collar installation.

### Ceramic Collar Manufacturing Process:

z. This process involves the use of the slab roller, the block clay, a wire clay cutter, and the ¾″ hole cutter.
aa. Set slab roller to a thickness, of ⅝″ thickness. Cut block clay into the longest and widest strips of the block to ¾″ thick. Place strips on slab roller and roll strips out to reach a thickness of ⅝″ thick.
bb. Using hole cutter, cut out disks, and place in a moist, foam lined, sealed container until ready to install.

### Ceramic Collar, and Feed Tube Insertion Hole, Installation Process:

cc. This process involves the wet ceramic slip casted balls, prefabricated collars, artist brush, wet slip, and ¼″ hole cutter.
dd. Pour slip into a flat bottomed container, and fill with slip to a ⅛″ thick layer.
ee. Take one collar at a time and dip one collar into slip. Place collar on precasted ball.
ff. Using artist brush, dip brush in to slip and seal connection between ball and collar.
gg. Place ball on foam egg crate and let sit until collar is firmly attached to ball.
hh. When the collar has set to a point of a firm, leather like consistency, use the ¼ clay hole cutter, and push into top center of collar until full penetration into ball, is achieved. Let dry at least 24 hours or until assembled emitters are not cold to the touch, and has little to no moisture content, as that can destroy the part in the firing process.

### Drying, Cleaning, and Firing Process for Assembled, Ceramic Part of Emitter:

ii. This process, involves the sanding sponge, sponge, water bowl, and kiln.
jj. After assembled ceramic part is thoroughly dried, the part must be cleaned of dangerous or undesirable flaws, such as part lines.
kk. Using the sanding sponge, sand off part lines, as not to sacrifice the integrity of the wall thickness of the part.
ll. Using the sponge and water sparingly, wipe the ball clean of any unsightly textures. Do not disturb the texture of the top of the collar, as this will sacrifice the adhesion of the bind between the top of the collar and the plastic feeder tube.
mm. At this point, the assembled emitters can be loaded into the kiln without the use of kiln shelves or stilts. The assembled parts can be filled to maximum capacity in any sized kiln. Set kiln to desired cone temperature. Turn on kiln and allow to fire. Kiln must never be opened or stopped during the firing cycle and allowed to cool to room temperature, or surrounding temperature of shop space, as the part's integrity can be sacrificed.

### Final Assembly of Ceramic Emitter is as Follows:

### Materials Needed for Final Assembly of Ceramic Emitter:

nn. Plastic irrigation tubing
oo. Finished ceramic emitter part.
pp. 2 part epoxy such as JB Weld
qq. 60 grit emory cloth
n. Vinegar
ss. Mixing cup
tt. Mixing stick (e.g., popsicle stick)

### Plastic Feeder Tube Preparation and Installation to Ceramic Part of Emitter:

uu. The top part of the collar must be dry, free of residue, and have as much texture, or “tooth” for the adhesive to bond. The weak point is the bond of the feeder tube to the ceramic part of the emitter.
vv. Cut lengths of plastic tubing to desired length, for application needed, to connect to main feed line of H2O.
ww. Sand the end of the plastic tube in a circular motion on the last 1½″ of feeder tube.
xx. Soak feeder tube length in 1 part vinegar and 3 parts water for 30 minutes, rinse, and allow to dry.
yy. Mix epoxy in mixing cup. Apply epoxy liberally, to the full sanded surface of feeder tube.
zz. Insert feeder tube into hole into top of ceramic emitter part. Move feeder tube in and out in a ¼″ movement as to seat the tube and adhesive to the ceramic part.
aaa. Finish with adhesive around the top of the collar and create a slope of adhesive from the outer top edge of the collar to ¼″ inch up the feeder tube.
bbb. Allow to dry 24 hours before use or packaging.
ccc. There are aspects of the Applicants' invention that are believed to go against conventional wisdom in the ceramic arts. For example, in producing the wall thickness of the emitter, according to one preferred formulation, applicants use a clay formulation with Custer Velspar, in place of 50 pounds more of talc in a 300 pound batch of clay. Also, Applicants use sodium silicate as a deflocculating agent in a manner which, if not used in the manner described herein, can ruin an entire batch of clay. Specifically, as the clay formulation is being mixed, the sodium silicate is added until the clay moves fluidly (to a visual observations) in the mixing tank.

Also, while it is common for clay to contain barium, Applicants' clay is barium free, and Applicants closely monitor the addition of sodium silicate, which does two main things; it seals and preserves the integrity of the inside mold surface, as well as yielding a thicker wall thickness of the casted container. Also, the formulation of the mold plaster is also important, and in Applicants' experience goes against common wisdom in the ceramic arts. Specifically, the standard for making a ceramic mold is to use potter's plaster #1, whereas Applicants use 20 minute casting plaster, which has no correlation to the ceramic community. The 20 minute casting plaster is widely used in the building industry, and not in the ceramic industry. The difference between the two is that potter's plaster #1 would be problematic in achieving the wall thickness needed in the ball shaped emitter as it does not pull the moisture from the clay as fast as the 20 minute casting plaster. Still further, in Applicants' mold making process, when Applicants prepare the master to make a plaster casting mold, Applicants go against common wisdom in the ceramic arts in that it is common to use mold soap, as a mold release on the master, but Applicants uses multiple coats of nitrocellulose lacquer on the master mold and vegetable oil as a release coating.

Thus, from the foregoing description, those in the art will appreciate how to manufacture and use a new and useful plant root system feeding device, that can efficiently and economically feed a plant root system.

With the foregoing disclosure in mind, it is believed that various adaptations of a plant root feeding device, system and method of making and using the plant root feeding device, according to the principles of the present invention, will be apparent to those in the art.

1. A plant root feeding device comprising
a. a fluid container formed of semi permeable material that allows fluid to pass from the inside of the container to a plant root located in ground in proximity to the fluid container, the fluid container having a fluid inlet opening,
b. a fluid Inlet tube in fluid communication with said fluid inlet opening of the fluid container, the fluid inlet tube having a fixed, fluid sealed coupling to the fluid inlet opening of the fluid container, and
c. the fluid container having a configuration that enables it to be located in ground in proximity to an in ground root system of a plant, and having a permeability that enables fluid to pass from the inside of the container to the in ground root system of a plant in proximity to the fluid container.

2. The plant root feeding device of claim 1, wherein the fluid container has a ball shaped configuration.

3. The plant root feeding device of claim 1, wherein the fluid container is formed of semi permeable ceramic material.

4. The plant root feeding device of claim 1, wherein the fluid inlet opening has a ceramic collar having a sealed, substantially permanent connection with the fluid container, and the fluid inlet tube is integrally connected with the ceramic collar.

5. The plant root feeding device of claim 4, wherein the ceramic container has a predetermined wall thickness, and the ceramic collar has a thickness that is larger than the predetermined wall thickness of the ceramic container.

6. The plant root feeding device of claim 5, wherein the ball shaped container has an outer diameter in the range of 1.5 inches to 5 inches and a wall thickness in the range of 0.25 inches to ½ inches.

7. The plant root feeding device of claim 6, wherein the ratio of the outer diameter of the container to the wall thickness is about 20 to 1.

8. The plant root feeding device of claim 6, wherein the outer diameter of the container is about 2.5 inches and the wall thickness of the container is about 0.125 inches.

9. The plant root feeding device of claim 3, wherein the ceramic material is barium free.

10. A plant root feeding system, comprising
a. a fluid container located in proximity to an in ground root system of a plant, the fluid container formed of semi permeable material that allows fluid to pass from the inside of the container to the soil in which the in ground root system of the plant is located, the fluid container having a fluid inlet opening,
b. a fluid Inlet tube in fluid communication with said fluid inlet opening, the fluid inlet tube having a fixed, fluid sealed coupling to the fluid inlet opening of the fluid container, and
c. the fluid inlet tube having a distal end in fluid communication with a source of plant feeding fluid.

11. The plant root feeding system of claim 10, wherein the fluid container has a ball shaped configuration.

12. The plant root feeding system of claim 10, wherein the fluid container is formed of semi permeable ceramic material.

13. The plant root feeding system of claim 10, wherein the fluid inlet opening has a ceramic collar having a sealed, substantially permanent connection with the fluid container, and the fluid inlet tube is integrally connected with the ceramic collar.

14. The plant root feeding system of claim 13, wherein the ceramic container has a predetermined wall thickness, and the ceramic collar has a thickness that is larger than the predetermined wall thickness of the ceramic container.

15. The plant root feeding system of claim 14, wherein the ball shaped container has an outer diameter in the range of 1.5 inches to 5 inches and a wall thickness in the range of 0.25 inches to ½ inches.

16. The plant root feeding system of claim 14, wherein the ratio of the outer diameter of the container to the wall thickness is about 20 to 1.

17. The plant root feeding system of claim 17, wherein the outer diameter of the container is about 2.5 inches and the wall thickness of the container is about 0.125 inches.

18. The plant root feeding system of claim 15, wherein the ceramic material is barium free.

19. A method of feeding a plant root comprising
a. providing a plant root feeding system comprising
i. a fluid container formed of semi permeable material that allows fluid to pass from the inside of the container to a plant root system located in ground in proximity to the fluid container, the fluid container having a fluid inlet opening,
ii. a fluid Inlet tube in fluid communication with said fluid inlet opening, the fluid inlet tube having a fixed, fluid sealed coupling to the fluid inlet opening of the fluid container, and a distal end in fluid communication with a source of plant feeding fluid,
iii. the fluid container having a configuration that enables it to be located in ground in proximity to the in ground root system of the plant, and having a permeability that enables fluid to pass from the inside of the container to the in ground root system of the plant
b. locating the fluid container in ground in proximity to the in ground root system of the plant, and feeding plant feeding fluid to the fluid container via the fluid inlet tube.

20. The plant root feeding method of claim 19, wherein a fluid reservoir is in fluid communication with the distal end of the fluid inlet tube, to provide a source of plant feeding fluid for the container.

21. The plant root feeding method of claim 20, wherein the fluid reservoir is located above the level of the fluid container, to enable a gravity feed of plant feeding fluid from the reservoir to the fluid container via the fluid feeding tube.

22. The plant root feeding method of claim 19, wherein the fluid container has a ball shaped configuration.

23. The plant root feeding method of claim 19, wherein the fluid container is formed of semi permeable ceramic material.

24. The plant root feeding method of claim 19, wherein the fluid inlet opening has a ceramic collar having a sealed, substantially permanent connection with the fluid container, and the fluid inlet tube is integrally connected with the ceramic collar.

25. The plant root feeding system of claim 24, wherein the ceramic container has a predetermined wall thickness, and the ceramic collar has a thickness that is larger than the predetermined wall thickness of the ceramic container.

26. The plant root feeding system of claim 25, wherein the ball shaped container has an outer diameter in the range of 1.5 inches to 5 inches and a wall thickness in the range of 0.25 inches to ½ inches.

27. The plant root feeding system of claim 25, wherein the ratio of the outer diameter of the container to the wall thickness is about 20 to 1.

28. The plant root feeding system of claim 25, wherein the outer diameter of the container is about 2.5 inches and the wall thickness of the container is about 0.125 inches.

29. The plant root feeding system of claim 23, wherein the ceramic material is barium free.

30. A method of manufacturing a ceramic fluid emitter having a hollow ball shaped container, a fluid inlet opening and a fluid inlet tube coupled to the fluid inlet opening, comprising
a. producing the hollow ball shaped container by
i. providing a ceramic mixture that includes a clay, water and sodium silicate,
ii. providing a casting mold formed of casting plaster, the casting mold configured to cast a hollow ball shaped container with the configuration of a collar support at its upper end,
iii. slip casting the ceramic mixture in the casting mold, and
iv. firing the slip cast ceramic mixture in a predetermined fashion to produce a predetermined porosity in the ball shaped fluid container; and
b. producing a collar and fluid inlet tube that are sealed to the upper end of the hollow ball shaped container with the fluid inlet tube in fluid communication with the interior of the hollow ball shaped container.

31. The method of claim 30, wherein the collar is produced by providing a preformed collar form, coating the collar form with the slip casting ceramic mixture, and placing the coated collar form in the collar support at the upper end of the container, such that the coated collar form when set in the container and fired with the container has a sealed relationship with the collar support at the upper end of the fluid container.

32. The method of claim 31, wherein the collar form has a central opening to enable the coated collar form to be coupled and sealed to a fluid inlet tube, with the fluid inlet tube in fluid communication with the interior of the ball shaped container.

33. The method of claim 30, wherein the principal components of the ceramic mixture are Laguna 207 dry clay, water and sodium silicate.

34. The method of claim 30, wherein the principal components of the ceramic material are Talc, KT ball clay, Custer Velspar Ball Clay, soda ash, water and sodium silicate.
